(19) United States
(12) Patent Application Publication
(10) Pub. No.: US 2015/0235368 A1
(43) Pub. Date: Aug. 20, 2015

(54) DISPLACEMENT DETECTION APPARATUS, SUBSTRATE PROCESSING APPARATUS, DISPLACEMENT DETECTION METHOD AND SUBSTRATE PROCESSING METHOD

(71) Applicant: SCREEN Holdings Co., Ltd., Kyoto (JP)

(72) Inventor: Hiroaki KAKUMA, Kyoto (JP)

(21) Appl. No.: 14/550,298

(22) Filed: Nov. 21, 2014

(30) Foreign Application Priority Data
Feb. 17, 2014 (JP) 2014-027456

(51) Int. Cl. G06T 7/00; G06K 9/00; G06K 9/52; G01B 11/14; H04N 7/18

(52) U.S. Cl. CPC G06T 7/0042; G01B 11/14; H04N 7/18; G06K 9/52; G06K 9/00624

(57) ABSTRACT

For detection of displacement of the nozzle which moves in the direction toward and away from the camera, the imaging direction of the camera is an oblique direction which intersects the plane of movement of the nozzle. In the image obtained by imaging, displacement of the nozzle is reflected as up-down movement. Therefore, as the position of the nozzle within the image is detected through pattern matching, displacement of the nozzle which contains a component along the depth direction of the image can be detected.

### CROSS REFERENCE TO RELATED APPLICATION

The disclosure of Japanese Patent Application No. 2014-027456 filed Feb. 17, 2014 including specification, drawings and claims is incorporated herein by reference in its entirety.

### BACKGROUND OF THE INVENTION

1. Field of the Invention

The present invention is directed to an apparatus of and a method for displacement detection by taking an image of an object to be positioned and detecting displacement from a reference position, and to an apparatus of and a method for substrate processing utilizing such techniques.

2. Description of the Related Art

In JP-A-2012-104732, a technique for coating a substrate with coating fluid is disclosed: A nozzle is located opposed to the center of rotation of a substrate which rotates while being held by a spin chuck, and as the nozzle injects coating fluid toward the center of rotation of the substrate, the surface of the substrate is coated with the coating fluid. An apparatus disclosed in JP-A-2012-104732 has two CCD cameras each of which takes an image of a suction hole formed at the center of the spin chuck and the nozzle within the horizontal plane (XY-plane) from two different directions which are orthogonal to each other (X-direction and Y-direction), detects whether displacement of the nozzle has occurred or not based upon the images, and adjusts the X-direction position and the Y-direction position of the nozzle.

### SUMMARY OF THE INVENTION

In the conventional technique above, the two CCD cameras, having the optical axes of which are orthogonal to each other in the horizontal direction, take the image of the nozzle which is an object which needs be positioned. Hence, one whose imaging direction is the Y-direction alone can detect displacement of the nozzle along the X-direction, the other whose imaging direction is the X-direction alone can detect displacement of the nozzle along the Y-direction. It is therefore indispensable to use two CCD cameras, and these CCD cameras are so disposed only for the purpose of determining the position of the nozzle. However, there is the need that displacement detection techniques like the one described above would be changed to use a smaller number of cameras (imaging devices) for reduction of the footprint and the cost and to allow more freedom with respect to the locations of the image capture units. The conventional technique above does not meet the need.

The invention has been made considering the problem above. Accordingly, an object of the invention is to provide a technique for detecting displacement of an object to be positioned from a reference position by imaging from only one imaging direction while ensuring a high level of freedom regarding the location of an imaging device.

A first aspect of the invention is directed to a displacement detection apparatus for detecting displacement of an object to be positioned from a reference position. The displacement detection apparatus comprises: an imaging device that images the object or a member which is displaced together with the object as a subject to be imaged; and a detector that detects displacement of the object based upon a subject image of the subject taken by the imaging device. In the apparatus, the imaging device takes the subject image in an imaging direction having a parallel component to the direction of displacement of the subject and a non-parallel component to the direction of displacement of the subject, and the detector detects a non-parallel component to the imaging direction in displacement of the object from the reference position based upon the result of pattern matching of the subject image against a reference image of the subject which is taken by the imaging device with the object positioned at the reference position.

A second aspect of the invention is directed to a substrate processing apparatus. The substrate processing apparatus comprises: a substrate holder that holds a substrate; a processor that performs predetermined processing of the substrate in a condition that the processor is opposed to the substrate; a positioning device that positions the processor at the opposed position which is opposed to the substrate; and a displacement detection apparatus that detects displacement of the processor from a reference position. In the apparatus, the displacement detection apparatus includes: an imaging device that images the processor or a member which is displaced together with the processor as a subject to be imaged; and a detector that detects displacement of the processor based upon a subject image of the subject taken by the imaging device, and the reference position is the position of the processor at the time that the processing of the substrate is started.

A third aspect of the invention is directed to a displacement detection method of detecting displacement of an object to be positioned from a reference position. The method comprises: an imaging step of imaging the object or a member which is displaced together with the object as a subject to be imaged and obtaining an subject image of the subject; and a detecting step of detecting displacement of the object based upon the subject image. In the method, at the imaging step, the subject is imaged in an imaging direction having a parallel component to the direction of displacement of the subject and a non-parallel component to the direction of displacement, and at the detecting step, a non-parallel component to the imaging direction included in displacement of the object from the reference position is detected based upon the result of pattern matching of the subject image against a reference image of the subject which is taken by the imaging device with the object positioned at the reference position.

A fourth aspect of the invention is directed to a substrate processing method. The method comprises: a substrate holding step of holding a substrate; a processor arranging step of moving a processor which performs predetermined processing of the substrate to a reference position set in advance and positioning the processor so that the processor is opposed to the substrate; a processing step of making the processor perform the processing of the substrate; an imaging step of imaging the processor or a member which is displaced together with the processor as a subject to be imaged and obtaining an subject image of the subject; and a detecting step of detecting displacement of the processor based upon the subject image. In the method, at the imaging step, the subject is imaged in an imaging direction which has a parallel component to the direction of displacement of the subject and a non-parallel component to the direction of displacement, at the detecting step, a non-parallel component to the imaging direction in displacement of the processor from the reference position is detected based upon the result of pattern matching of the subject image against a reference image of the subject which is taken by the imaging device with the processor positioned at the reference position, and prior to the processing step, the imaging step and the detecting step are executed to determine whether the processor is positioned at the reference position is determined.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a schematic drawing which shows the structure of a substrate processing system according to an embodiment of the invention;

FIG. 2 is a plan view which shows the structure of one substrate processing unit;

FIG. 3 is a drawing which shows the cross section of FIG. 2 taken along the arrow A-A and shows the structure of the controller of the substrate processing unit;

FIG. 4 is a flow chart which shows the operation of the substrate processing unit;

FIG. 5 is a drawing which shows an example of how the images change when the substrate is eccentric;

FIGS. 6A through 6C are drawings which show the principle of detecting a change from the images;

FIG. 7 is a flow chart of the wet processing;

FIG. 8 is a flow chart of teaching processing;

FIGS. 9A, 9B, 10A, 10B and 10C are drawings which show how nozzle displacement manifests itself in images;

FIG. 11 is a flow chart of the deviation inspection; and

FIG. 12 is a drawing which shows primary portions according to the other embodiment of the invention.

### DETAILED DESCRIPTION OF THE PREFERRED EMBODIMENTS

A substrate processing system comprising a substrate processing apparatus to which the invention is applicable will now be briefly described. In the following, a substrate may be any one of various types of substrates such as a semiconductor substrate, a glass substrate for photo mask, a glass substrate for liquid crystal display, a glass substrate for plasma display, a substrate for FED (Field Emission Display), an optical disk substrate ,a magnetic disk substrate and a magneto-optic disk substrate. While the following will describe as an example a substrate processing system used primarily for processing of a semiconductor substrate with reference to drawings, the invention is applicable to processing of various types of substrates mentioned above.

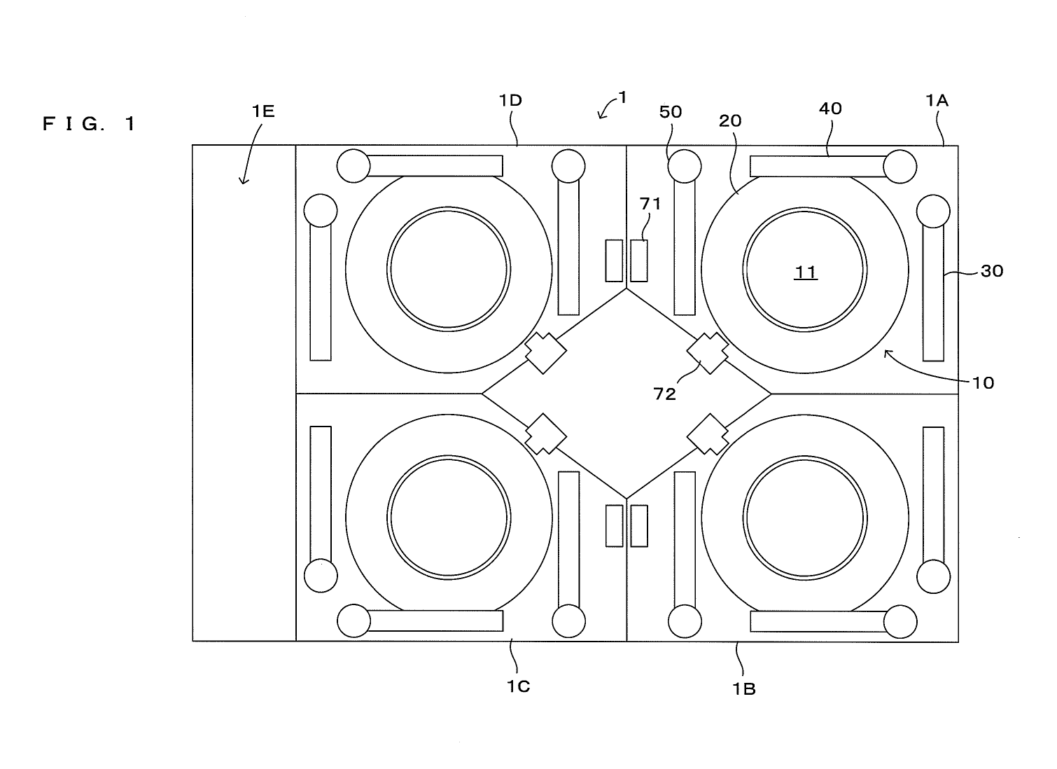

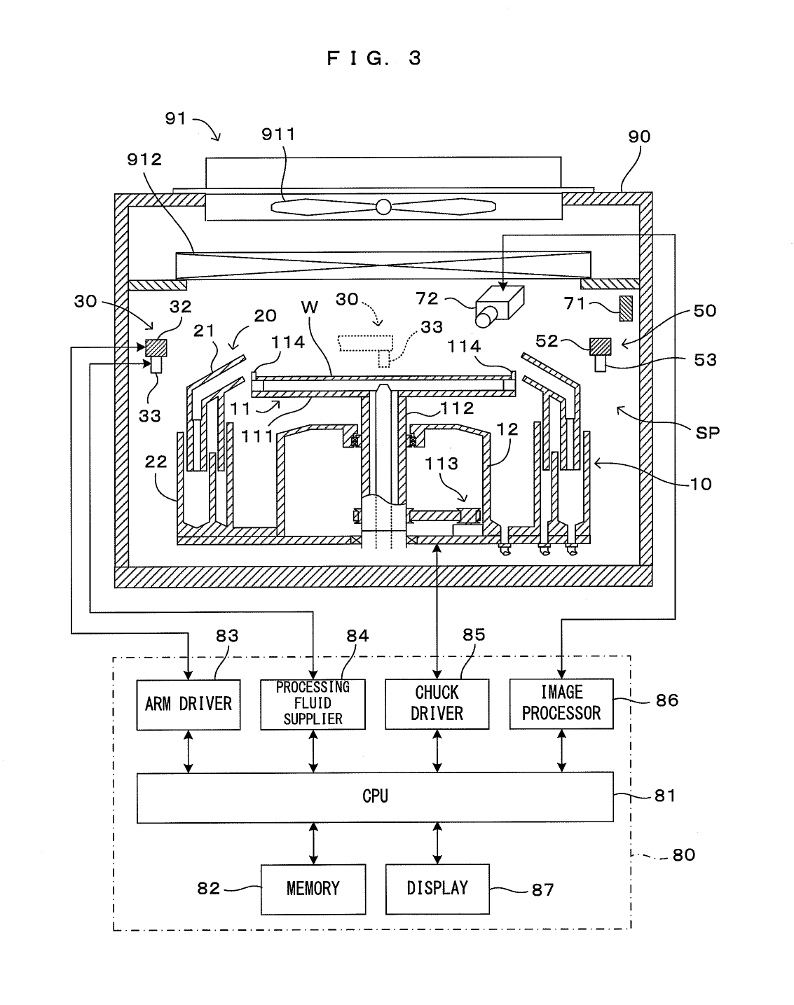

FIG. 1 is a schematic drawing which shows the structure of a substrate processing system according to an embodiment of the invention. To be more specific, FIG. 1 is a plan view which shows an embodiment of a substrate processing system comprising a substrate processing apparatus to which the invention is applied in a preferable fashion. The substrate processing system 1 comprises substrate processing units 1A, 1B, 1C and 1D which are capable of executing predetermined processing of a substrate independently of each other, an indexer 1E equipped with an indexer robot (not shown) which is for transferring the substrate from the substrate processing units 1A, 1B, 1C and 1D to outside and vice versa, and a controller 80 (FIG. 3) which controls operations of the entire system. Any number of substrate processing units may be disposed, and more than one layers each housing four substrate processing units which are arranged horizontally may be stacked one atop the other.

The substrate processing units 1A, 1B, 1C and 1D are identical to each other with respect to structural elements and operations, although the layout of the structural elements is partially different depending upon the locations of these units within the substrate processing system 1. The following will describe the structure and operations of the substrate processing unit 1A but will omit describing the other semiconductor processing units 1B, 1C and 1D in detail.

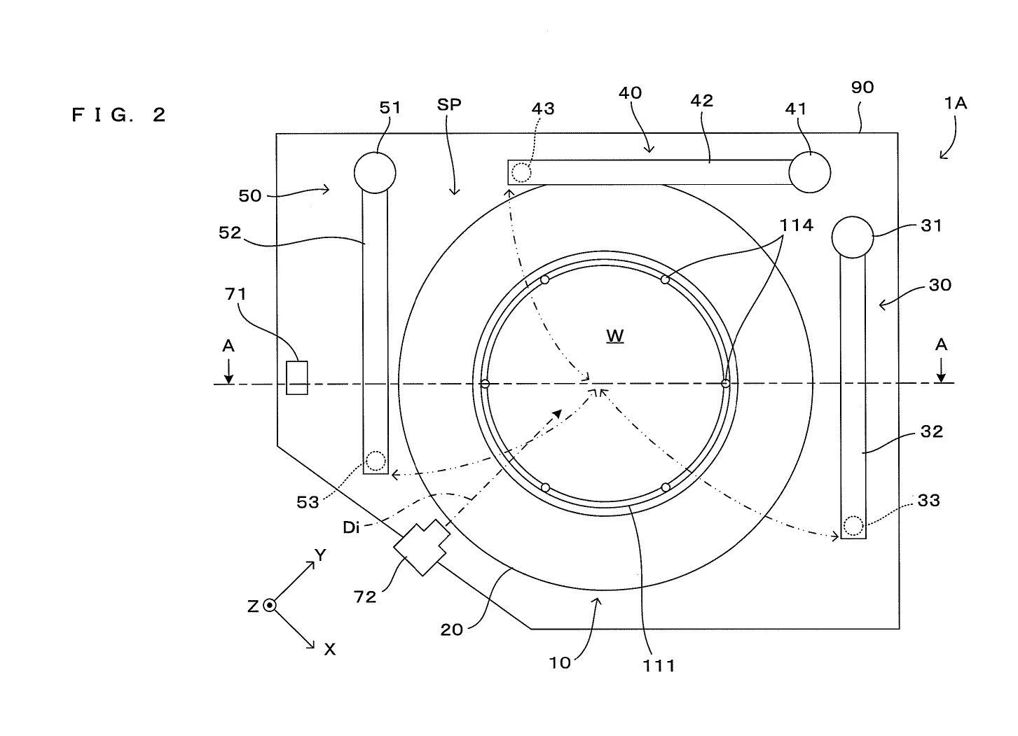

FIG. 2 is a plan view which shows the structure of one substrate processing unit. FIG. 3 is a drawing which shows the cross section of FIG. 2 taken along the arrow A-A and shows the structure of the controller of the substrate processing unit. The substrate processing unit 1A is a wet processing unit of the single wafer processing type for executing wet processing, such as cleaning and etching using a processing fluid, of a disk-shaped substrate W such as a semiconductor wafer. In the substrate processing unit 1A, a fan filter unit (FFU) 91 is disposed to a ceiling section of a chamber 90. The fan filter unit 91 comprises a fan 911 and a filter 912. External atmosphere which is admitted as the fan 911 operates is supplied into a processing space SP which is inside the chamber 90. The substrate processing system 1 is used as it is installed inside a clean room, and the processing space SP continuously receives clean air all times.

A substrate holder 10 is disposed inside the processing space SP of the chamber 90. The substrate holder 10 is for rotating the substrate W while maintaining the substrate W in an approximate horizontal posture so that the top surface of the substrate W is directed toward above. The substrate holder 10 comprises a disk-shaped spin base 111 whose outer diameter is slightly larger than the substrate W and a spin chuck 11 which is integrated and linked with a rotation support shaft 112 which elongates approximately along the vertical direction. The rotation support shaft 112 is linked with the rotation shaft of a chuck rotating mechanism 113 which includes a motor so that it is possible for the spin chuck 11 to rotate about the rotation shaft (the vertical axis) when driven by a chuck driver 85 of the controller 80. The rotation support shaft 112 and the chuck rotating mechanism 113 are housed inside a cylindrical casing 12. The spin base 111 is integrated and linked with the top end of the rotation support shaft 112 by a fastening component such as a screw, and the spin base 111 is supported by the rotation support shaft 112 approximately horizontally. Hence, as the chuck rotating mechanism 113 operates, the spin base 111 rotates about the vertical axis. The controller 80 controls the chuck rotating mechanism 113 via a chuck driver 85, which makes it possible to adjust the rotation speed of the spin base 111.

There are a plurality of chuck pins 114 for grabbing the substrate W at the peripheral edge which are disposed in the vicinity of the peripheral edge of the spin base 111. There may be three or more (six in this example) such chuck pins 114 for the purpose of securely holding the circular substrate W. The cuck pins are disposed at equal angular intervals along the peripheral edge of the spin base 111. Each chuck pin 114 is structured so as to be able to switch between the pressing state in which it presses the exterior peripheral edge surface of the substrate W and the released state in which it is off the exterior peripheral edge surface of the substrate W.

Each one of the chuck pins 114 is released when the substrate W is handed over to the spin base 111 but remains in the pressing state when the substrate W is rotated and subjected to predetermined processing. When in the pressing state, the chuck pins114 can hold the substrate W at the peripheral edge of the substrate and keep the substrate W approximately horizontally over a predetermined gap from the spin base 111. Thus, the substrate W is supported with its top surface directed toward above and its bottom surface directed toward below. The chuck pins 114 may be of a known structure such as that disclosed in JP-A-2013-206983 for instance. The mechanism for holding substrates is not limited to chuck pins but may instead be a vacuum chuck which sucks the substrate W at the back surface of the substrate and thereby holds the substrate.

Around the casing 12, a splash guard 20 is disposed which surrounds the substrate W which is held horizontally by the spin chuck 11 in such a manner that the splash guard 20 can freely move upward and downward along the rotation shaft of the spin chuck 11. The splash guard 20 has an approximately rotation symmetric shape with respect to the rotation shaft, and comprises a plurality of guards 21 (two guards in this example), which are each disposed concentric to the spin chuck 11 and receive a splashed processing fluid from the substrate W, and a fluid receiver 22 which receives the processing fluid flowing down from the guards 21. As a guard up-down mechanism not shown disposed to the controller 80 makes the guards 21 ascend or descend stepwise, it is possible to segregate and collect a processing fluid such as a chemical solution and a rinse solution splashed around from the rotating substrate W.

Around the splash guard 20, at least one fluid supplier is disposed which provides the substrate W with various types of processing fluids such as a chemical solution which may be an etching solution, a rinse solution, a solvent, pure water and DIW (deionized water). In this example, as shown in FIG. 2, there are three fluid dischargers 30, 40 and 50. The fluid discharger 30 comprises a revolving shaft 31, which can revolve about the vertical axis when driven by an arm driver 83 of the controller 80, an arm 32 extending horizontally from the revolving shaft 31, and a nozzle 33 which is attached as it is directed toward below to the tip end of the arm 32. As the arm driver 83 drives the revolving shaft 31, the arm 32 swings about the vertical axis, whereby the nozzle 33 reciprocally moves between a retracted position which is outward beyond the splash guard 20 (i.e., the position denoted by the solid line in FIG. 3) and a position above the center of rotation of the substrate W (i.e., the position denoted by the dotted line in FIG. 3) as shown by the two-dot chain line in FIG. 2. The nozzle 33, while staying above the substrate W, discharges a predetermined processing fluid supplied from a processing fluid supplier 84 of the controller 80 and accordingly supplies the processing fluid to the substrate W.

Similarly, the processing fluid discharger 40 comprises a revolving shaft 41 which is driven by the arm driver 83, an arm 42 linked with this revolving shaft, and a nozzle 43 which is attached to the tip end of the arm 42 and discharges the processing fluid fed from the processing fluid supplier 84. The processing fluid discharger 50 comprises a revolving shaft 51 which is driven by the arm driver 83, an arm 52 linked with this revolving shaft, and a nozzle 53 which is attached to the tip end of the arm 52 and discharges the processing fluid fed from the processing fluid supplier 84. The number of the processing fluid dischargers is not limited to this but may be increased or decreased as needed.

In a condition that the substrate W is rotating at a predetermined rotation speed as the spin chuck 11 rotates, the processing fluid dischargers 30, 40 and 50 supply the processing fluid to the substrate W while the nozzles 33, 43 and 53 become positioned above the substrate W one after another, thereby performing wet processing of the substrate W. Different processing fluids or the same processing fluid may be discharged at the nozzles 33, 43 and 53 in accordance with the purpose of processing. Alternatively, two or more types of processing fluids may be discharged from one nozzle. The processing fluid supplied to the vicinity of the center of rotation of the substrate W spreads outwardly due to centrifugal force which develops as the substrate W rotates, and eventually gets drained off toward the side from the peripheral edge of the substrate W. The processing fluid thus splashed by the substrate W is then received by the guards 21 of the splash guard 20 and collected by the fluid receiver 22.

The substrate processing apparatus 1A further comprises an illuminator 71 which illuminates inside the processing space SP and a camera 72 which takes an image of the surface of the substrate W which is held by the spin chuck 11. The illuminator 71 uses an LED lamp as a light source for instance, and provides illumination light into inside the interior of the processing space SP which is needed for taking an image with the camera 72. The camera 72 is disposed at a higher position as compared with the substrate W along the vertical direction, and its imaging direction Di (i.e., the direction of the optical axis of the imaging optical system) is set as a downwardly oblique direction toward the approximate center of rotation in the surface of the substrate W so as to take an image of the top surface of the substrate W. The entire surface of the substrate W held by the spin chuck 11 thus comes into inside the field of view of the camera 72.

The illuminator 71 and the camera 72 may be disposed inside the chamber 90, or they may be disposed outside the chamber 90 so as to illuminate or take an image of the substrate W via a transparent window of the chamber 90.

Image data output from the camera 72 are fed to an image processor 86 of the controller 80. The image processor 86 then performs predetermined image processing of the image data. As described later in detail, in this embodiment, in accordance with images taken by the camera 72, how the nozzles 33, 43 and 53 are positioned and how the substrate W is held is determined.

In addition to the above, the controller 80 of the substrate processing system 1 comprises a CPU 81 which executes a processing program set in advance and accordingly controls operations of the respective parts, a memory 82 which stores the processing program executed by the CPU 81, data created during processing, etc. and a display 87 which informs a user as needed of a progress in processing, abnormality, etc. Each one of the substrate processing units 1A through 1D may have one such controller 80, or only one controller 80 may be disposed for the substrate processing system 1 for control of all substrate processing units 1A through 1D. Further, the CPU 81 may function as an image processor as well.

For the convenience of description later, the XYZ-orthogonal coordinate axes are set as shown in FIG. 2. The XY-plane is the horizontal plane and the Z-direction is the vertically upward direction. Among the coordinate axes in the horizontal direction (namely, the X-axis and the Y-axis), the Y-axis is parallel to the direction in which the imaging direction Di of the camera 72 is projected upon the horizontal plane and the X-axis is orthogonal to this.

The operation of the substrate processing unit 1A having the structure above will now be described. The other substrate processing units 1B through 1D operate similarly although they will not be described. Through the indexer 1E, the substrate processing unit 1A receives the substrate W which has been transported from outside and supplies various types of processing fluids while rotating the substrate W, thereby executing wet processing. A number of known techniques are available which use various types of processing fluids for wet processing, and any such technique may be used.

Inside the substrate processing unit 1A, the substrate W is rotated as it is set to the spin chuck, and how the chuck 11 holds substrate W is determined before wet processing of the substrate at a predetermined rotation speed starts. That is, during the period since the substrate W starts rotating until the substrate W reaches the processing speed, how the substrate W is held is determined using images taken by the camera 72. When it is determined that the substrate W is held in a normal state, scheduled wet processing is executed. When it is determined that the substrate W is held in an abnormal state, the substrate W is stopped rotating immediately. This processing will now be described below.

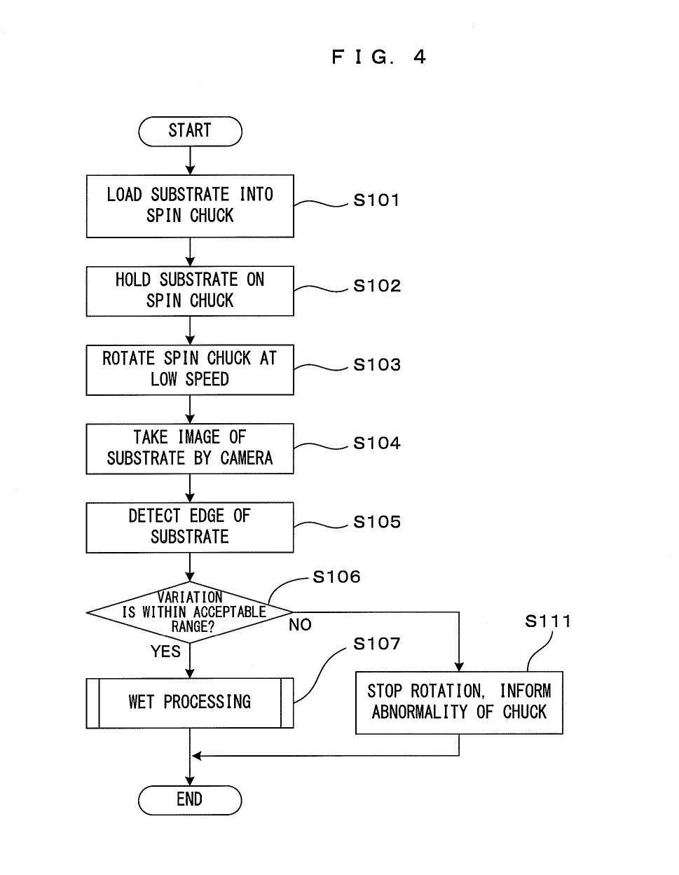

FIG. 4 is a flow chart which shows the operation of the substrate processing unit. This operation is realized as the CPU 81 executes the predetermined processing program. The substrate W is loaded into the substrate processing unit 1A and is then set to the spin chuck 11, i.e., the plurality of chuck pins 114 which are disposed to the peripheral edge of the spin base 111 (Step S101). During loading of the substrate W, the chuck pins 114 disposed to the spin base 111 are in the released state but switch to the pressing state after the substrate W is set at the chuck pins 114 and accordingly hold the substrate W (Step S102).

For the reason that the substrate W is set to an inappropriate position for instance, the chuck pins 114 could only incompletely hold the substrate W. For example, the substrate W could get caught by and stranded on any one of the chuck pins 114 while being set and could be held as it is tilted from its horizontal posture. Or for instance, the shapes of the chuck pins 114 could gradually change as a chemical solution corrodes the chuck pins 114, in which case it becomes impossible to hold the substrate W or the substrate W could be held in an eccentric state.

When the substrate W rotates in such a state, it may fall off from the spin chuck 11 and get damaged or it may collide the structural elements inside the chamber 90 and damage the apparatus. Even if the substrate W does not fall off, if the substrate W rotates as it is tilted or in an eccentric posture, abnormal vibration may occur in the apparatus. To prevent such a problem from occurring, in the substrate processing unit 1A, behaviors of the substrate W are observed using images captured with the camera 72 and how the substrate W is held by the chuck pins 114 is determined.

In more specific words, while the chuck driver 85 operates and the spin chuck 11 rotates at a low speed (Step S103), the camera 72 continuously or intermittently takes images of the substrate W (Step S104). As a result, a plurality of images of the substrate W which have different rotation phase angles from each other are obtained. The image processor 86 thereafter performs edge extraction processing of each one of thus obtained images, thereby detecting the positions of the edge (peripheral edge) of the substrate W in the images (Step S105). The CPU 81 determines how the spin chuck 11 is holding the substrate W based upon variation of the detected edge position.

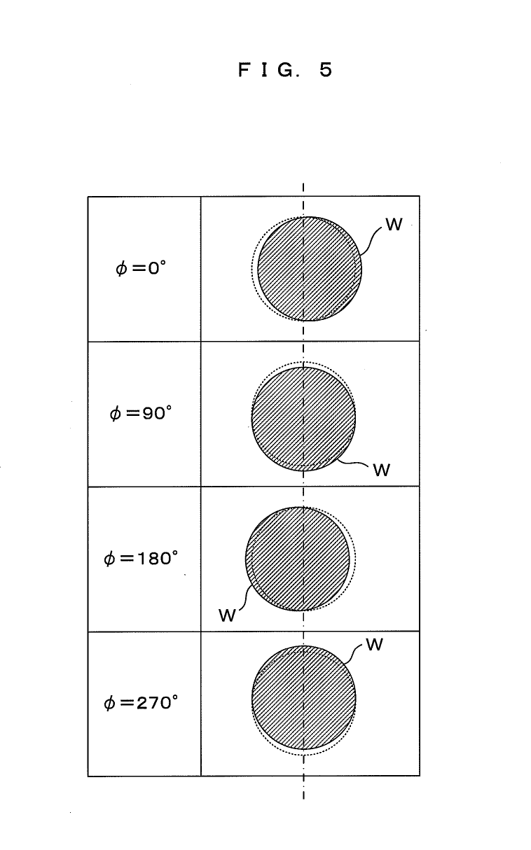

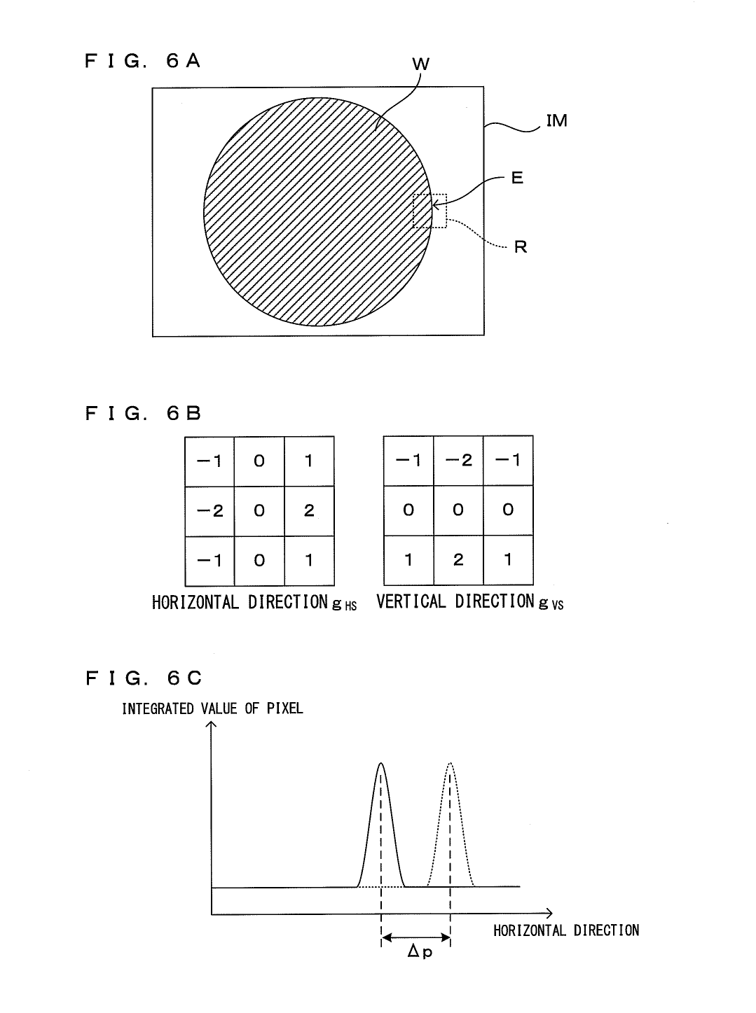

FIG. 5 is a drawing which shows an example of how the images change when the substrate is eccentric. FIGS. 6A through 6C are drawings which show the principle of detecting edge variation from the images. Comparing the plurality of images which were taken in a condition that the rotation phase angle cp about the vertical axis of the substrate W rotating together with the spin chuck 11 changed, as shown in FIG. 5, one can see that the image of the substrate W appears at deviated positions from the dotted-line positions which have no eccentricity and that the direction of deviation changes in accordance with the value of the rotation phase angle φ. It then follows that by detecting the position of the edge of the substrate W within the images and calculating the variation, i.e. amount of shifting by which the position of the edge changes, it is possible to determine whether eccentricity has occurred.

Specifically, as shown in FIG. 6A, in the image IM, a partial region R which potentially includes the edge E of the substrate W is noted. Edge extraction processing is performed, thereby detecting in the region R a position at which the density of the image dramatically changes due to an optical characteristic difference between the substrate W and the background portion, and the detected position is determined as the edge position of the substrate W.

When the size of the region R is sufficiently small relative to the diameter of the substrate W, in the region R, the edge E of the substrate W can be taken as approximately linear. As shown in FIG. 6A, in the event that the region R is set such that the edge E of the substrate W crosses the region R approximately perpendicularly within the image for instance, by identifying a position at which the value of a pixel greatly changes along the horizontal direction within the region R, it is possible to detect the edge position of the substrate W. The horizontal direction and the perpendicular direction in this context mean the traversal direction and the vertical direction in the image respectively, which is a different concept from the positions in the apparatus.

Edge extraction may be realized through processing which uses a known Sobel filter for instance. During this processing, a certain pixel within an image (which is the region R in this context) is used as a pixel-to-note, the pixel values of the pixel-to-note and the eight surrounding pixels, i.e., the nine pixels in total, are multiplied by the coefficients shown in FIG. 6B, and the products thus calculated are summed up. This calculation is performed using the two coefficient matrices along the horizontal direction and the perpendicular direction of the image.

The pixel value g after filtering of the pixel-to-note can be calculated from the formula below:

g=(g_{HS}²+gᵥₛ²)^{1/2}

where the horizontal-direction sum is g_{HS} and the perpendicular-direction sum is g_{VS}. Through such computation, an image of different nature is obtained whose edge section is enhanced bright unlike the surrounding area in the image.

As the pixel value g of each pixel within the region R is added up along the perpendicular direction and plotted relative to positions in the horizontal direction, peaks appear at positions which correspond to the edge E of the substrate W as shown in FIG. 6C. When the substrate W is eccentric, the peak positions periodically vary in accordance with the rotation phase angle φ. A peak position difference Δp means the difference between the state denoted by the solid line that the peak position has shifted the most to the left-hand side as the substrate W rotates and the state denoted by the dotted line that the peak position has shifted the most to the right-hand side as the substrate W rotates. Thus, the difference Δp is indicative of the amplitude by which the edge position of the substrate W shifts due to the eccentricity. A threshold value for the value Δp is set in advance. It is possible to determine that the eccentricity of the substrate W is within an allowable range when the value Ap is equal to or below the threshold value and that eccentricity outside the allowable range has occurred when the value Ap is beyond the threshold value.

Referring back to FIG. 4, the CPU 81 determines whether variation of the edge position of the substrate W thus detected is within an acceptable range, i.e., whether the variation is equal to or below the threshold value (Step S106). When the variation is within the acceptable range (when YES), it is determined that how the substrate W is held is normal, followed by wet processing in accordance with a processing recipe which has been determined in advance (Step S107).

Meanwhile, when the variation of the edge position of the substrate W which has occurred as the rotation phase angle changed is outside the acceptable range (when NO at Step S106), it is determined that how the substrate W is held is abnormal. The spin chuck 11 is immediately stopped rotating and the substrate W is consequently stopped rotating, which the display 87 informs the user of by an indicated message which tells that the substrate W is abnormally held by the spin chuck 11 (Step S111). Instead of or in addition to the indicated message, an alarm sound may be provided for example to inform of the abnormality.

As the camera 72 keeps taking images while the substrate W rotates at a low speed and how the substrate W is held is determined from the variation, i.e. the amount of relative shifting of the edge value of the substrate W among the plurality of images in which the rotation phase angle of the substrate W is different. Hence, it is possible to prevent the substrate W which is inappropriately held from rotating at a high speed and consequently damaging itself, the apparatus, etc.

It is when taking images of the substrate W is done downwardly from right above approximately along the vertical direction that the images of the substrate W become circular as shown in FIGS. 5 and 6A. In this embodiment, the camera 72 takes images of the substrate W from an upward oblique direction, in the actual images, the substrate W is approximately oval in a strict sense. The principle of detection above is nevertheless applicable even in this case.

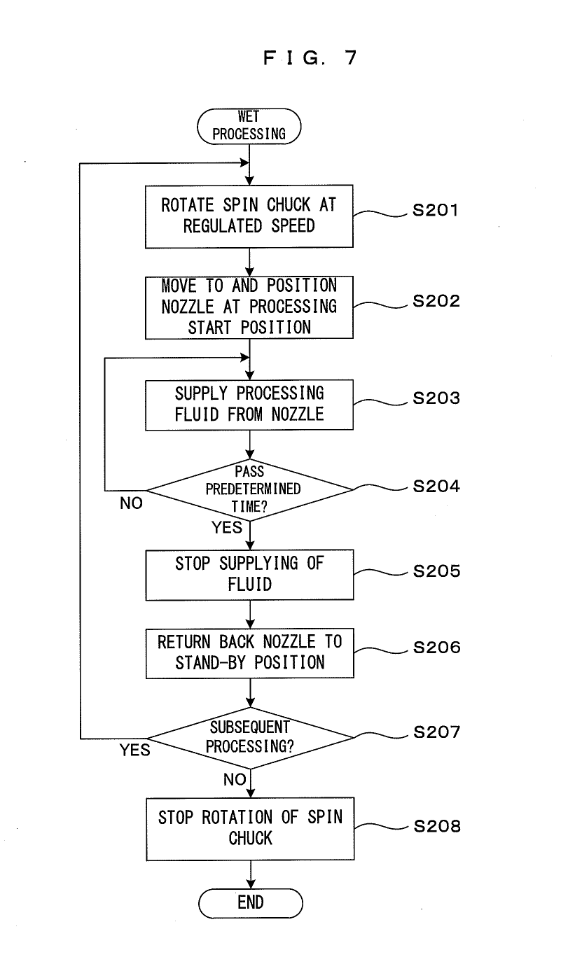

FIG. 7 is a flow chart of the wet processing. The wet processing is carried out as the CPU 81 controls the respective parts of the apparatus according to a processing recipe which has been set in advance. Initially, the rotation speed of the spin chuck 11 which has been rotating slowly for the purpose of determining how the substrate W is held is changed to a regulated speed which is appropriate to the processing (Step S201). In general, this regulated speed is faster than the rotation speed for determining how the substrate W is held.

Following this, one of the nozzles 33, 43 and 53 designated according to the processing recipe is moved to and positioned at a processing start position (Step S202). Specifically describing this, the CPU 81 controls the arm driver 83, whereby one of the arms 32, 42 and 52 which supports the designated nozzle revolves and the nozzle attached to this arm is positioned at the predetermined processing start position. In the example described here, the processing start position for each nozzle is above the center of rotation of the substrate W.

In the event that the processing with the nozzle 33 is executed for instance, the arm 32 revolves in response to a control command given from the CPU 81 and sets the nozzle 33 to the position above the center of rotation of the substrate W. In this condition, the nozzle 33 discharges a predetermined processing fluid and the processing fluid is supplied to the center of the substrate W which is rotating (Step S203). The substrate W is thus processed with the processing fluid. As the processing fluid is supplied to the center of the substrate W, the processing fluid uniformly spreads over the surface of the substrate W due to centrifugal force, which makes it possible to uniformly process the surface of the substrate W.

After supplying of the processing fluid has been continued for a predetermined period of time (Step S204), supplying of the processing fluid is stopped (Step S205), and the nozzle 33 returns back to a stand-by position which is off the substrate W sideways from above the substrate W (Step S206). This completes the processing with the processing fluid supplied from the nozzle 33. When there is processing to be executed subsequently (YES at Step S207), the processing is continued from Step S201. In this manner, processing with the processing fluid supplied from the nozzle 43 and processing with the processing fluid supplied from the nozzle 53 for example are carried out sequentially. The sequence of the processing is not limited to this and only some of the nozzles 33, 43 and 53 may be used for the processing. Further, the same nozzle may be used more than one times during a series of processing.

After completion of all processing, the spin chuck 11 stops rotating (Step S208), which makes it possible to unload the substrate W which has been processed from the apparatus. Spin drying may be performed as needed during or after the wet processing.

In general, the processing start position for nozzle is not limited to the center of rotation of the substrate W but may any desired position. For instance, during processing which requires supplying a processing fluid only to the peripheral edge of the substrate W, the processing start position for nozzle is a position above the peripheral edge. An alternative structure may be that after the nozzle is set at the processing start position, the nozzle moves along and accordingly scans the surface of the substrate W while supplying a processing fluid.

In any mode, for appropriate execution of the wet processing, the nozzles need be properly set at the processing start position determined in advance. In this type of processing apparatus, the processing start position for nozzle is taught by an operator (teaching) in advance according to a processing recipe, and the CPU 81 controls the arm driver 83 so as to move the nozzle to the designated position according to the teaching. However, due to a cause such as deviation of the arm or the nozzle due to unintended contact with other component or the like and deterioration with time of any structural element, positioning of the nozzle may become less accurate and it may become impossible to properly set the nozzle to the processing start position.

If the nozzle gets thus displaced, it may become impossible to obtain a desired processing result which is expected from the processing recipe, potentially leading to a problem that the processing throughput becomes low or processing defects increase and the yield deteriorates. To prevent such, it is necessary to periodically check whether the nozzle is properly set to the predetermined processing start position. The structure according to this embodiment allows the CPU 81 to perform as needed deviation inspection in which the camera 72 takes an image of the positioned nozzle and whether the nozzle is set to the correct position is determined based upon the result of imaging. The principle of the deviation inspection and the specific content of the processing will now be described below.

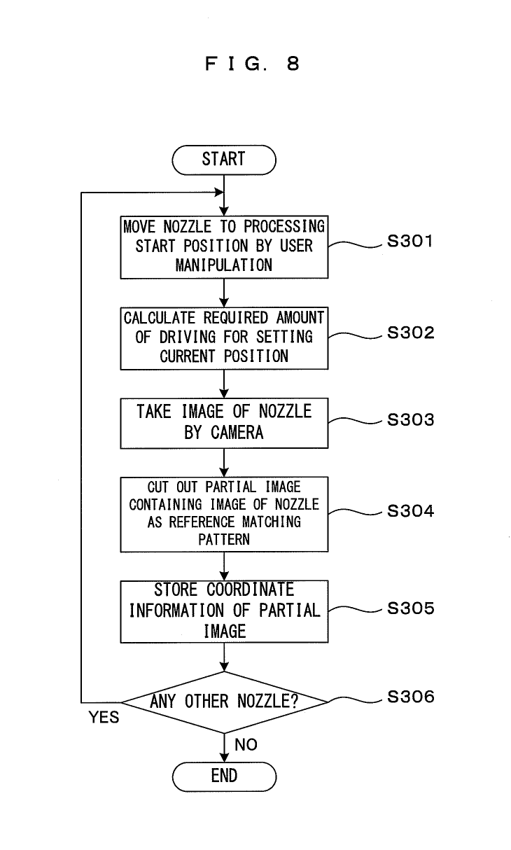

FIG. 8 is a flow chart of teaching processing. The teaching processing is processing for a user (operator) to set a position which the nozzle to discharge a processing fluid during wet processing demanded by a processing recipe must be set to, and is carried out prior to execution of the wet processing according to the processing recipe. The teaching processing is executed as needed for each one of the nozzles 33, 43 and 53. A plurality of positions may be set for one nozzle. The example described here assumes that teaching is performed with respect to the processing start position once for each one of the nozzles 33, 43 and 53 in this order.

First, teaching is performed for the nozzle 33. At the beginning, through user manipulation performed by an operator, the nozzle 33 is moved to and set at the processing start position (Step S301). This nozzle movement may be achieved as the operator manually moves the arm 32 or as the operator enters an operation command to the arm driver 83. The position thus set by the operator is the processing start position for the nozzle 33, and the CPU 81 calculates a required amount of driving by which the arm 32 needs be driven for the purpose of moving and setting the nozzle 33 at the current position from the stand-by position (Step S302). A physical amount which represents the required amount of driving may for instance be a drive pulse number, position information, etc. The drive pulse number is provided to a stepping motor (not shown) which is disposed to the arm driver 83 for revolving the arm 32. The position information is output by a rotary encoder disposed to the arm driver 83 for detecting the position of the arm 32.

The required amount of driving thus calculated is stored in the memory 82. At the time of executing the wet processing, the CPU 81 provides the arm driver 83 with a control command based upon the required amount of driving, and as the arm 32 revolves exactly by a desired amount, the nozzle 33 supported by the arm 32 is positioned to the processing start position which has been set in advance. This is enough for teaching in a narrow sense which simply aims at accepting and storing the setting regarding the processing start position.

Meanwhile, in this embodiment, the nozzle 33 thus positioned by the operator is imaged by the camera 72 and the state set by the operator is stored as an image (Step S303). This image will now be referred to as “the reference image.” Imaging at this stage is performed under the same imaging condition as that for taking the image of the substrate W. That is, the location of the camera 72, the imaging magnification and the like are common between taking the image of the nozzle described here and taking the image of the substrate W for determining how the substrate W is held.

The image processor 86 cuts out a partial image containing the image of the nozzle 33 from the reference image through image processing (Step S304). The partial image is stored in the memory 82 as a reference matching pattern which will be used for later nozzle position assessment. Coordinate information indicating the location of the partial image within the overall image is also stored in the memory 82 (Step S305).

Teaching regarding one position for one nozzle 33 in this embodiment is thus completed. When there is other nozzle for which teaching needs be performed (YES at Step S306), similar teaching is performed for the other nozzle 43, 53 or the like, starting from Step S301. In this manner, the processing start position for the nozzles 33, 43 and 53 in the wet processing is set.

The teaching carried out in this fashion and moving of the nozzles 33, 43 and 53 during the wet processing in accordance with the required amount of driving obtained as a result of the teaching must mean that each nozzle is set to the processing start position set in advance. However, if the accuracy of nozzle positioning deteriorates due to such a reason described above, the positions of the nozzles may potentially be deviated from the intended processing start position even though the nozzles are driven exactly by the same amount of driving. Noting this, in this embodiment, whether the nozzles 33, 43 and 53 positioned owing to driving provided by the arm driver 83 are set to the processing start position is determined using the images of the nozzles 33, 43 and 53 taken by the camera 72.

As shown in FIG. 2, in the substrate processing apparatus 1A according to this embodiment, the arms 32, 42 and 52 are disposed at the three locations inside the chamber 90 and the arms 32, 42 and 52 revolve horizontally about their respective revolving shafts. As a result, the nozzles 33, 43 and 53 move between their stand-by positions which are off sideways from the substrate W and the processing start position which is above the center of rotation of the substrate W. Since the nozzles 33, 43 and 53 come into the field of view of the camera 72 when set at the processing start position, it is possible to detect the locations of the nozzles from the images of the nozzles taken by the camera 72. However, displacement of the nozzles may not necessarily be clear in the images since the directions in which the nozzles move as the arms revolve are different.

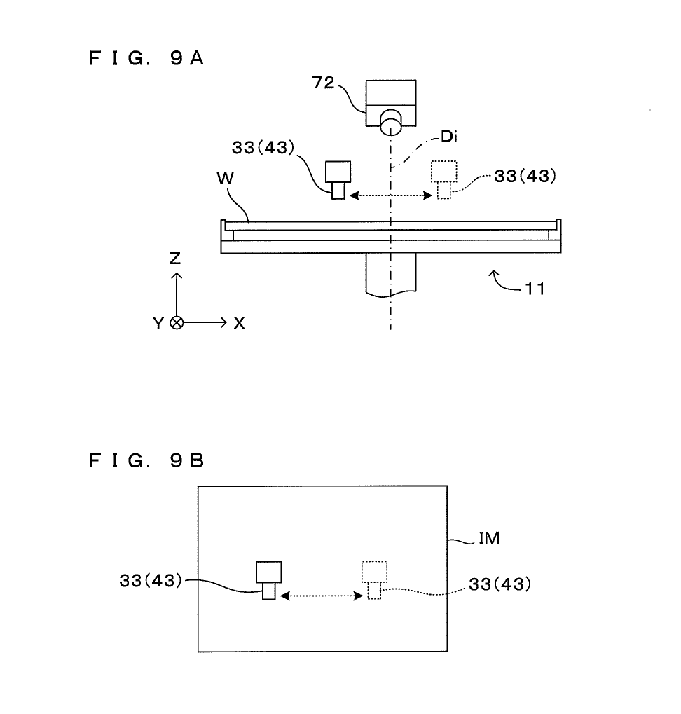

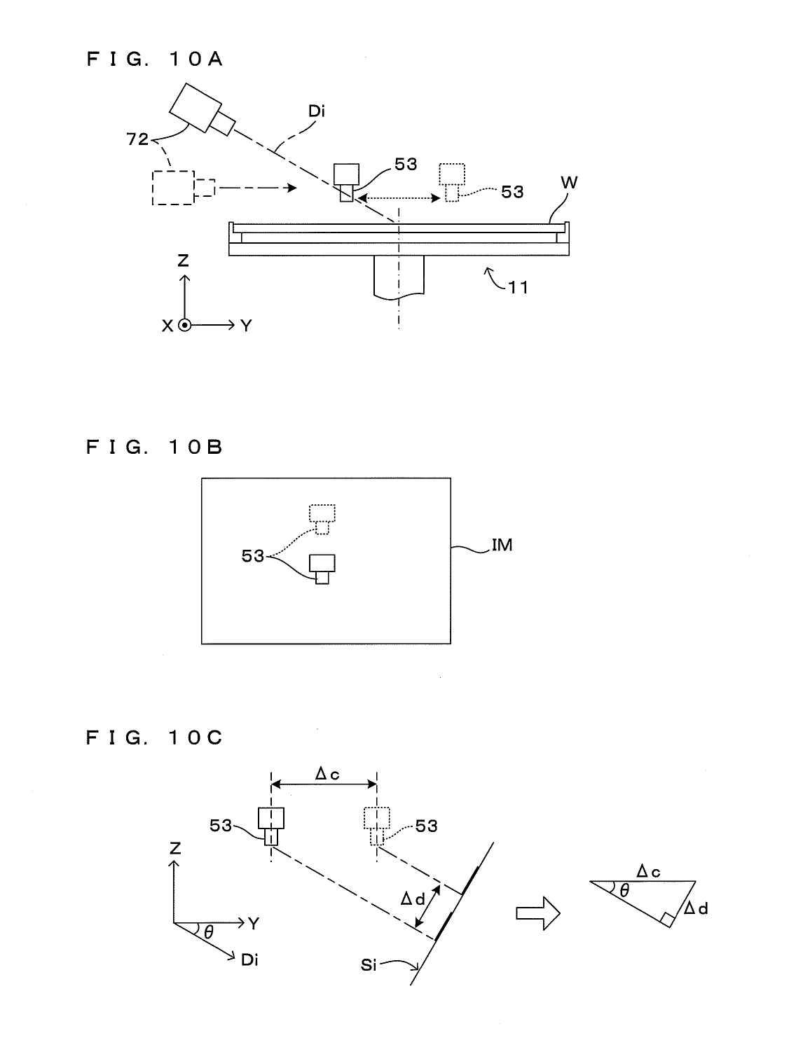

FIGS. 9A, 9B, 10A, 10B and 10C are drawings which show how nozzle displacement manifests itself in images. FIGS. 9A and 9B are indicative of an example that the nozzle 33 or 43 is imaged, while FIGS. 10A and 10B are indicative of an example that the nozzle 53 is imaged. As shown in FIGS. 2 and 9A, in an area which is near and above the center of rotation of the substrate W, the nozzle 33 (or the nozzle 43) horizontally moves approximately along the X-axis direction which is orthogonal to the Y-axis direction which is parallel to the parallel component of the imaging direction Di for the camera 72. Hence, the nozzle 33 (or 43) moves crossing the field of view of the camera 72, which manifests itself as sideways displacement in the captured image IM as shown in FIG. 9B. It is therefore relatively easy to detect the displacement of the nozzle from the image IM. In short, the amount of displacement within the image can be approximated as blow:

Δb≈M·Δa

where Δa is the amount of actual displacement of the nozzle 33 (43) and M is the imaging magnification.

In contrast, within an area which is near and above the center of rotation of the substrate W, the nozzle 53 horizontally moves approximately the Y-axis direction which is parallel to the parallel component of the imaging direction Di of the camera 72 as shown in FIGS. 2 and 10A. That is, movement of the nozzle 53 primarily contains a component in a direction toward and away from the camera 72, namely, a component which is parallel to the imaging direction Di of the camera 72. Therefore, as denoted by the broken line in FIG. 10A, if the imaging direction of the camera 72 is approximately horizontal, displacement of the nozzle 53 shows itself as extremely small displacement in the image, which is difficult to detect.

In this embodiment, the camera 72 is disposed so as to look down on the substrate W from the side of and above the substrate W and the imaging direction Di of the camera 72 is a downward oblique direction. In other words, the plane of movement which is a plane containing the trajectory of the nozzle 53 is horizontal, whereas the camera 72 is disposed so that the imaging direction Di intersects the plane of movement. That is, the camera 72 performs imaging in the imaging direction Di which is the direction containing a component which is parallel (parallel component) to the direction of displacement of the nozzle 53 (horizontal direction) and a component which is not parallel (vertical component) to this direction of displacement. For this reason, as shown in FIG. 10B, displacement of the nozzle 53 in the horizontal direction is reflected upon the image IM as it is projected along the up-down direction. It is therefore possible to detect from the image IM this displacement although it is displacement which contains the parallel component to the imaging direction Di of the camera 72.

Displacement of the nozzle 53 within the image is the projection of actual displacement upon a surface Si which is perpendicular to the imaging direction Di as shown in FIG. 10C. From the relationship shown in the right-hand side area in FIG. 10C, the amount of displacement Δd of the nozzle 53 within the image can be approximated as follows:

Δd≈M·Δc·sin θ

where Δc denotes the amount of actual displacement, M denotes the imaging magnification and θ denotes the angle of the imaging direction Di with respect to the horizontal direction. This relationship needs be taken into consideration when it is necessary to quantitatively calculate the amount of displacement of the nozzle from an image.

In a substrate processing apparatus which has a plurality of nozzles around a substrate, some nozzles inevitably move nearly along the direction in which a camera images, due to a restriction with respect to layout as described above. In light of this, the substrate processing apparatus 1A according to this embodiment combines imaging of the nozzle 53 from the upward oblique direction described above with deviation inspection described below, thereby making it possible to precisely detect deviation of the nozzle 53 from the processing start position even if displacement of the nozzle 53 is hard to detect.

During the deviation inspection processing described below, it is possible to determine whether the other nozzles 33 and 43 have deviated from the processing start position in addition to detection concerning the nozzle 53. The deviation inspection processing is executed at appropriate timing prior to execution of the wet processing, such as immediately after start-up of the substrate processing system 1 which was shut down, at the time of switching over to a production lot of substrates to be processed and upon completion of periodic maintenance work. Alternatively, the deviation inspection processing may be executed in response to an instruction from the operator.

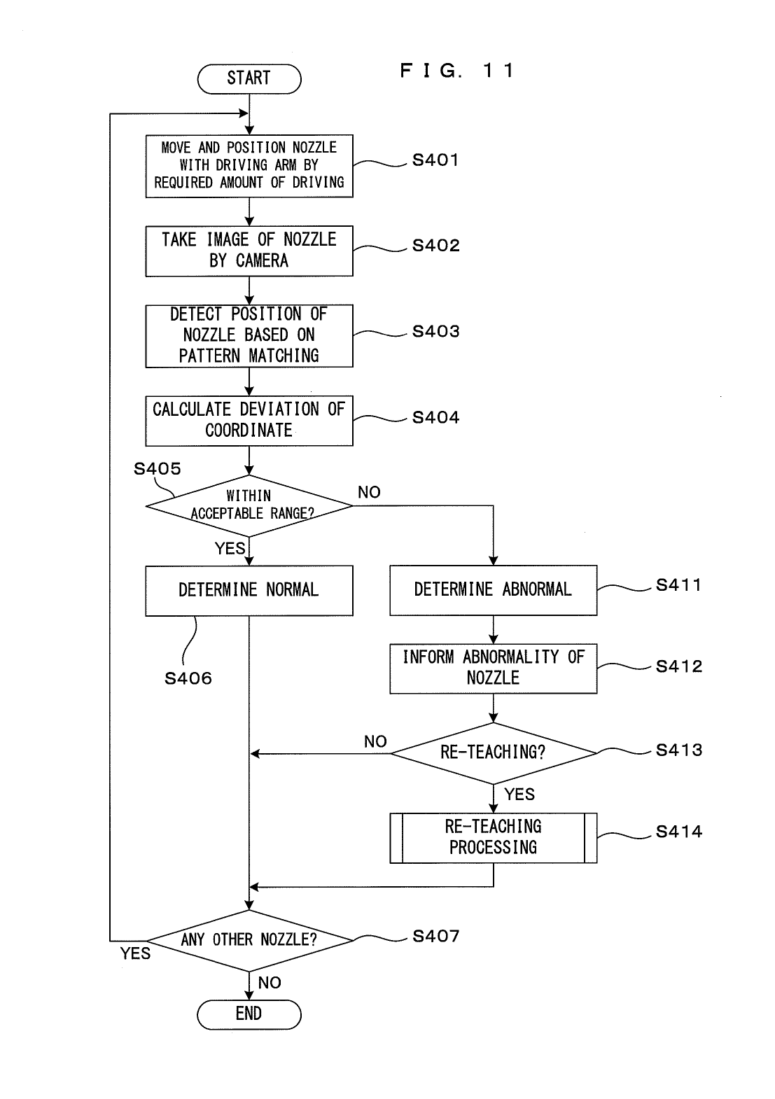

FIG. 11 is a flow chart of the deviation inspection. First, the CPU 81 control the arm driver 83, whereby one arm supporting one nozzle (the nozzle 53 in this example) is moved and positioned by the required amount of driving calculated through the teaching processing (Step S401). Unless there is abnormality with the apparatus, the nozzle 53 must be at the processing start position taught by the operator.

The camera 72 takes an image of the nozzle 53 (Step S402) and the image including the image of the nozzle 53 is obtained. The image acquired at this stage will be referred to as the “subject image.” The image processor 86 then performs pattern matching of thus obtained subject image against a reference matching pattern which is the partial image which was previously cut out during the teaching processing (Step S403). There are various conventional techniques concerning pattern matching for searching for a portion of an image which matches with or is similar to a known reference pattern. Such a technique may be used in this embodiment and will therefore not be described in detail here.

Detection of a segment of the subject image, which matches with or is similar at a high degree of correlation to the reference matching pattern acquired in advance through the pattern matching processing, means identification of the position of the nozzle 53 inside the subject image. A difference is calculated between the coordinate position of this segment within the subject image and the coordinate position of the partial image serving as the reference matching pattern within the reference image imaged during the teaching processing, thereby calculating how much the nozzle 53 is currently deviated from the position of the object to be processed (Step S404).

The CPU 81 determines whether the amount of deviation is within an acceptable range (Step S405). For instance, as a threshold value is set in advance for the scalar amount representing deviation within the plane of the image and the calculated amount of deviation is compared with the threshold value, it is possible to determine whether the deviation is within the acceptable range. When this decision is to be made based upon the difference of the coordinates within the image, threshold values need be appropriately set for the nozzles 33, 43 and 53 considering the characteristics shown in FIGS. 9A, 9B, 10A, 10B and 10C. Once the threshold values have been set, it is possible to determine based solely upon the coordinate values within the image and it is therefore unnecessary to convert into the amounts of actual displacement of the nozzles.

It is determined that the nozzle 53 has been positioned normally when the amount of deviation is within the acceptable range (Step S406). In this case, whether there is other nozzle to inspect is determined (Step S407), and when there is, the processing is back to Step S401 to inspect the other nozzle. In contrast, when the amount of deviation is outside the acceptable range, it is determined that the nozzle 53 has been positioned abnormally (Step S411). In this case, the operator is informed of the abnormality with the nozzle 53 and asked whether to execute the teaching processing once again (Step S412).

When re-teaching needs be performed (Step S413), the teaching processing shown in FIG. 8 is executed again as re-teaching processing (Step S414). When re-teaching is not necessary, similar inspection is performed on the other nozzle as needed, starting at Step S407.

In such a structure above that one camera 72 images displacement of the plurality of nozzles under the same imaging condition, it is possible that the camera 72 cannot focus on all nozzles. With respect to displacement which is in a direction toward and away from the camera 72 in particular, it may be difficult to encompass the displacement in its entirety within the focusing range. However, in the event that the required nozzle positioning accuracy (acceptable range of deviation) is approximately 0.5 mm for instance, it is sufficiently possible to take an image of the nozzle deviated in the entire acceptable range within the depth of field.

Even if the nozzle cannot be focused upon, a clear image therefore cannot be obtained and the location of the nozzle cannot be detected from within the image, it is possible to determine from that fact the nozzle is not properly positioned. This applies also to a situation that the nozzle is outside the imaging range.

The substrate processing system 1 according to the embodiment performs pattern matching of the images containing the nozzles 33, 43 and 53 captured by the camera 72 against the reference matching patterns cut out from the reference images which were captured with the respective nozzles set at the processing start position. Whether each nozzle is appropriately set at the processing start position is determined based upon the result of pattern matching. It is therefore possible to effectively prevent a processing failure owing to execution of the wet processing with any inappropriately positioned nozzle.

In this case, as for the nozzle 53 which primarily moves in the direction toward and away from the camera 72, displacement if any of the nozzle 53 can be reflected in the image and detected since the imaging direction Di of the camera 72 is a direction which intersects the plane of movement of the nozzle 53.

In this embodiment, the camera 72 is used for the purpose of imaging the nozzles and determining how the nozzles are positioned and also for the purpose of determining how the substrate W is held by the spin chuck 11. While the conventional technique according to JP-A-2012-104732 mentioned earlier requires two cameras for detecting the location of one nozzle, this embodiment uses one camera 72 to determine the states of the three nozzles 33, 43 and 53 and the substrate W. This makes it possible to significantly reduce the size and the cost of the substrate processing system 1.

As described above, according to this embodiment, it is possible to detect displacement of one nozzle through imaging from one imaging direction and it is also possible to detect displacement of even more than one nozzles through imaging from only one imaging direction. It is therefore possible to reduce the size and the cost of the apparatus. As long as the condition that particularly the nozzle which moves in the direction toward and away from the camera is imaged from an oblique direction such that the optical axis of the camera intersects the plane of movement of this nozzle is satisfied, the camera may be installed at any location. This provides a high degree of freedom of design.

As described above, in this embodiment, the substrate processing apparatuses 1A through 1D which form the substrate processing system 1 function as “the substrate processing apparatus” of the invention, and as each such apparatus operates, “the substrate processing method” of the invention is performed. Of the substrate processing apparatus 1A and the like, the camera 72 functions as “the imaging device” of the invention, while the CPU 81 and the image processor 86 function as “the detector” of the invention. These elements as they operate together function as “the displacement detection apparatus” and “the displacement detector” and the nozzles 33, 43 and 53 correspond to “the object to be positioned” and “the subject to be imaged” of the invention. The processing start position for each nozzle corresponds to “the reference position” of the invention.

Further, in the substrate processing apparatus 1A according to the embodiment above, the spin chuck 11 functions as “the substrate holder” of the invention, and the nozzles 33, 43 and 53 function as “the processor” of the invention. The arm driver 83 and the arms 32, 42 and 52 all function as “the positioning device” of the invention. The CPU 81 functions also as “the determining device” and “the holding state determining device” of the invention. The nozzles 33, 43 and 53 each functions also as “the fluid supplier” which supplies a predetermined processing fluid to the substrate W.

The invention is not limited to the embodiment described above but may be modified in various manners in addition to the embodiments above, to the extent not deviating from the object of the invention. For instance, although “the displacement detection apparatus” of the invention is built into the substrate processing apparatus 1A or the like in advance according to the embodiment above and the embodiment is therefore particularly directed to detection of displacement of the nozzle 33 or the like, the displacement detection apparatus of the invention which comprises the imaging device which takes an image of an object and the detector which detects displacement of the object based on the image taken by the imaging device is not limited to an apparatus which is built in equipment but may be an independent apparatus. The object whose displacement is detected may be anything.

In the embodiment above, the camera 72 takes the image of the nozzle 33 or the like which is “the object to be positioned” and displacement of the object to be positioned is detected. In this sense, “the object to be positioned” itself is “the subject to be imaged” for the camera 72. However, the subject to be imaged is not limited only to the object itself but may be a member which gets displaced as the object to be positioned is displaced. For instance, in the embodiment above, the nozzle 33 and the like are mounted in the one-to-one relationship to the arm 32 and the like and move together with the arm 32 and the like as the arm 32 and the like revolve. Considering this, a portion of the arm 32 or the like which can be easily detected within an image may become the member and be treated as the subject to be imaged, in which case this portion is imaged and displacement of this portion is detected so that displacement of the nozzle 33 or the like is indirectly detected. In addition, for this purpose, the arm 32 and the like or the nozzle 33 and the like may be locally marked with easily detectable identifiers which can be easily detected through image processing.

While the camera 72 images while encompassing nearly all surface of the substrate W within its field of view in the embodiment above, this is not a requirement. As described above, for the purpose of detecting nozzle displacement in the embodiment, imaging of the nozzle which is in the vicinity of the center of rotation of the substrate W is enough. For the purpose of determining how the substrate W is held, containing the edge E of the substrate W partially within the imaging range is enough. However, the structure according to the embodiment that imaging is executed with the entire substrate W contained within the field of view is preferable in that the location of the nozzle set through teaching is not limited to a position which is near the center of rotation of the substrate W and that various positions may be “the reference position” of the invention and displacement of the nozzle from “the reference position” can be detected.

Further, according to the embodiment above, displacement of the plurality of nozzles is detected using one camera 72 and how the substrate W is held is determined using the same camera 72. However, the displacement detection method of the invention is applicable also to a situation that there is only one nozzle (object to be positioned) or how the substrate is held is not detected.

While “the processor” in the substrate processing apparatus 1A, etc. according to the embodiment above includes the nozzle 33 and the like which supply processing fluids to the substrate W, “the processor” of the invention can be a nozzle which discharges a gas for instance in addition to a nozzle which discharges a liquid. In addition, a unit described below which abuts on the substrate W and processes the substrate W can function as “the processor” of the invention.

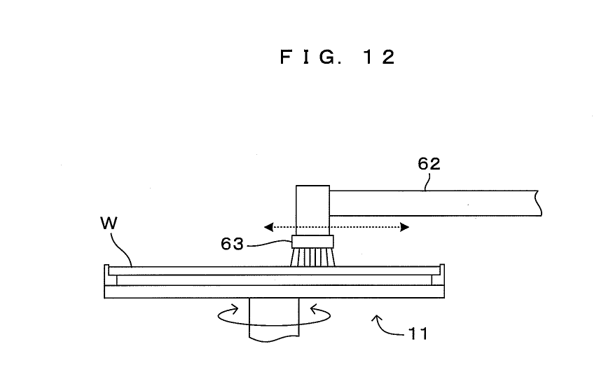

FIG. 12 is a drawing which shows primary portions according to the other embodiment of the invention. As “the processor” of the invention, the nozzle 33 and the like which are opposed to the substrate W and discharge a processing fluid are disposed according to the embodiment above. Instead of these, a brush 63 attached to the tip end of an arm 62 which rotates functions as “the processor” of the invention in the example shown in FIG. 12. As the brush 63 slides on the surface of the substrate W, physical cleaning of the substrate W is attained. The invention encompasses in its scope such a structure as well that uses an “abutting device” which abuts on the substrate W and processes the substrate W.

The invention is favorably applied to a displacement detection apparatus for and a displacement detection method of imaging the object to be positioned and detecting displacement of the object to be positioned from the reference position. The invention is suitable to the technical field regarding substrate processing in which the processor which processes a substrate is the object to be positioned for instance.

In these aspects of the invention, the subject to be imaged is imaged in the imaging direction (i.e., the direction of the optical axis of an imaging optical system if any of the imaging device) which contains the parallel component to the direction of displacement of the subject and the non-parallel component to the direction of displacement. Hence, the non-parallel component to the direction of displacement of the subject manifests itself as displacement of the subject within an image taken by the imaging device. For this reason, by pattern matching of the subject image which potentially contains displacement of the subject associated with displacement of the object to be positioned from the reference position against the reference image which is obtained by imaging the subject with the object to be positioned set to the reference position, the displacement can be detected.

Thus, according to the invention, imaging in the imaging direction which is the direction which contains the parallel component to the direction of displacement of the subject and the non-parallel component to the direction of displacement and pattern matching between the subject image and the reference image make detection of displacement of the object to be positioned possible through imaging from a single imaging direction. In addition, since it is also possible to image from various imaging directions which contain the parallel component to the direction of displacement of the subject and the non-parallel component to the direction of displacement, a high degree of freedom is ensured regarding the location of the imaging device which takes images.

In the displacement detection apparatus, for instance, the detector may detect displacement of the object based upon how the position of the subject is different between the subject image and the reference image which are taken while the position of the imaging device relative to the reference position remained the same. In this manner, it is easy to yield displacement of the subject within the image.

For the same reason, the displacement detection method may be constructed as follows: prior to the detecting step, the reference image is obtained by imaging the object set to the reference position within the same field of view as that for the subject image, and at the detecting step, displacement of the object is detected based upon how the position of the subject is different between the reference image and the subject image.

In the above case, for instance, the detector may find the position of the subject within the subject image through pattern matching in which a partial image, cut out from the reference image so as to contain the subject, is used as a reference pattern. Thus, it is possible through pattern matching to identify where an image content corresponding to the subject thus cut out from the reference image is located within the subject image. Further, since the position of the partial image within the reference image is known, it is possible from the information pertaining to these positions to find displacement of the subject within the subject image.

For the same reason, the displacement detection method may be constructed as follows: information, regarding the position of a partial image corresponding to the subject inside the reference image, is obtained as reference information, and at the detecting step, the position of a partial image corresponding to the subject inside the subject image is identified, and the identified information is compared with the reference information to detect displacement of the object is detected.

Another aspect of the invention is directed to a substrate processing apparatus that comprises: a substrate holder that holds a substrate; a processor that performs predetermined processing of the substrate in a condition that the processor is opposed to the substrate; a positioning device that positions the processor at the opposed position which is opposed to the substrate; and a displacement detection apparatus that detects displacement of the processor from a reference position, wherein the displacement detection apparatus includes: an imaging device that images the processor or a member which is displaced together with the processor as a subject to be imaged; and a detector that detects displacement of the processor based upon a subject image of the subject taken by the imaging device, and the reference position is the position of the processor at the time that the processing of the substrate is started.

In this structure according to the invention, in accordance with whether the displacement detector having the characteristics above has detected displacement of the processor not, whether the processor for processing the substrate is correctly positioned at the proper location can be determined, and it is therefore possible to prevent defective processing caused by inappropriate positioning. Only one imaging device may be used for this purpose, in which case an increase of the footprint for and the cost of installing the apparatus can be suppressed.

Further another aspect of the invention is directed to a substrate processing method that comprises: a substrate holding step of holding a substrate; a processor arranging step of moving a processor which performs predetermined processing of the substrate to a reference position set in advance and positioning the processor so that the processor is opposed to the substrate; a processing step of making the processor perform the processing of the substrate; an imaging step of imaging the processor or a member which is displaced together with the processor as a subject to be imaged and obtaining an subject image of the subject; and a detecting step of detecting displacement of the processor based upon the subject image, wherein at the imaging step, the subject is imaged in an imaging direction which has a parallel component to the direction of displacement of the subject and a non-parallel component to the direction of displacement, at the detecting step, a non-parallel component to the imaging direction in displacement of the processor from the reference position is detected based upon the result of pattern matching of the subject image against a reference image of the subject which is taken by the imaging device with the processor positioned at the reference position, and prior to the processing step, the imaging step and the detecting step are executed to determine whether the processor is positioned at the reference position is determined.

It is possible to avoid processing failures due to execution of the processing with the processor inappropriately positioned, which benefit is similar to that of the substrate processing apparatus described above.

In the substrate processing apparatus, for instance, the positioning device may move the processor along a plane of movement which contains the reference position, and the imaging device may have an optical axis and is disposed so that the optical axis intersects the plane of movement. In this structure, since imaging is performed in the imaging direction which intersects the plane of movement of the processor, it is possible to reflect any displacement of the processor within the plane of movement upon the image without fail, and therefore, to detect the displacement from the reference position without fail.

The substrate processing apparatus may be constructed so that the positioning device causes the processor to make movement which contains a parallel component to the direction of the optical axis projected upon the plane of movement. It is possible to determine whether the processor has been displaced or not by detecting the non-parallel component which is not parallel to the optical axis from among the displacement of the processor.

The substrate processing apparatus may also comprises a plurality of such processors that are moved independently of each other by the positioning device and imaged by the single imaging device. In this structure which comprises the plurality of processors which are capable of moving independently of each other, during imaging by one imaging device from the single imaging direction, any one of the other processors may be displaced in the direction which contains the parallel component to the imaging direction. Even on such an occasion, when the imaging direction contains a non-parallel component to the direction of displacement, it is possible to detect the displacement using the displacement detection technique according to the invention.

The substrate processing apparatus may be constructed so that the substrate holder holds the substrate in a horizontal posture, and the positioning device makes the processor move horizontally. When the invention is applied to this structure, the imaging direction of the imaging device is inclined with respect to the horizontal direction, i.e., a direction which contains a component along an up-down direction, it is possible to securely reflect displacement of the processor which moves horizontally upon the imaging result.

The substrate processing apparatus may further comprises a positioning determining device that determines that the position of the processor is inappropriate when the size of displacement of the processor from the reference position exceeds a threshold value set in advance. When this structure is used, it is possible to process while properly controlling the positioning accuracy of the processor.

The substrate processing apparatus may further comprises a holding state determining device and may be constructed as follows: the imaging device at least partially images the substrate which is held by the substrate holder, and the holding state determining device determines how the substrate is held by the substrate holder based upon the result of imaging concerning the substrate. Since this structure enables the imaging device to function not only for the purpose of positioning the processor but also for determining how the substrate is held, the function becomes even more advanced while the size and the cost of the apparatus are reduced. Where the displacement detection technique according to the invention is used, a high degree of freedom concerning the arrangement of the imaging device is ensured, and therefore, the imaging device can thus serve also for the other purpose.

In the substrate processing apparatus, the processor may be a fluid supplier which supplies a predetermined processing fluid to the substrate. This is applicable for example to processing of the surface of the substrate with a chemical solution supplied to the substrate, cleaning of the surface of the substrate with a cleaning solution, etc. Further, the processor may be an abutting device that abuts on the surface of the substrate and processes the substrate. This is for example a situation that the surface of the substrate is rubbed and accordingly cleaned or polished. When this structure is used, if the processor is not positioned at an appropriate position relative to the surface of the substrate, processing may not be attained. Such a problem can be solved by applying the invention to this structure.

The substrate processing method may be constructed as follows: when this structure is used, it is possible to process while appropriately controlling the positioning accuracy of positioning the processor, as in the case of the substrate processing apparatus described above.

The substrate processing method may comprises a teaching step of accepting user's work of positioning the processor and storing this position as the reference position before the processor arranging step and may be constructed so that the teaching step is executed again when the position of the processor is inappropriate. In this fashion, during the subsequent substrate processing, it is possible to set the processor at the appropriate position.

The substrate processing method may comprises a holding state determining step of at least partially imaging the substrate which is held at the substrate holding step and determining how the substrate is held based upon the result of imaging and may be constructed so that the holding state determining step is executed prior to the processing step. Since this structure enables the imaging device to function not only for the purpose of positioning the processor but for determining how the substrate is held, as in the case of the substrate processing apparatus described above.

According to the invention, imaging in the imaging direction which is the direction containing the parallel component and the non-parallel component to the direction of displacement of the subject and pattern matching of the subject image against the reference image make it possible to detect displacement of the object to be positioned through imaging from the single imaging direction. Further, since it is possible to image from various imaging directions which contain the parallel component and the non-parallel component to the direction of displacement of the subject, it is possible to ensure a high degree of freedom concerning the arrangement of the imaging device as well which performs imaging.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A displacement detection apparatus for detecting displacement of an object to be positioned from a reference position, the apparatus comprising:
an imaging device that images the object or a member which is displaced together with the object as a subject to be imaged; and
a detector that detects displacement of the object based upon a subject image of the subject taken by the imaging device,
wherein the imaging device takes the subject image in an imaging direction having a parallel component to the direction of displacement of the subject and a non-parallel component to the direction of displacement of the subject, and
the detector detects a non-parallel component to the imaging direction in displacement of the object from the reference position based upon the result of pattern matching of the subject image against a reference image of the subject which is taken by the imaging device with the object positioned at the reference position.

2. The displacement detection apparatus according to claim 1, wherein the detector detects displacement of the object based upon how the position of the subject is different between the subject image and the reference image which are taken while the position of the imaging device relative to the reference position remained the same.

3. The displacement detection apparatus according to claim 2, wherein the detector finds the position of the subject within the subject image through pattern matching in which a partial image, cut out from the reference image so as to contain the subject, is used as a reference pattern.

4. A substrate processing apparatus, comprising:
a substrate holder that holds a substrate;
a processor that performs predetermined processing of the substrate in a condition that the processor is opposed to the substrate;
a positioning device that positions the processor at the opposed position which is opposed to the substrate; and
a displacement detection apparatus that detects displacement of the processor from a reference position,
wherein the displacement detection apparatus includes: an imaging device that images the processor or a member which is displaced together with the processor as a subject to be imaged; and a detector that detects displacement of the processor based upon a subject image of the subject taken by the imaging device, and
the reference position is the position of the processor at the time that the processing of the substrate is started.

5. The substrate processing apparatus according to claim 4, wherein the positioning device moves the processor along a plane of movement which contains the reference position, and
the imaging device has an optical axis and is disposed so that the optical axis intersects the plane of movement.

6. The substrate processing apparatus according to claim 5, wherein the positioning device causes the processor to make movement which contains a parallel component to the direction of the optical axis projected upon the plane of movement.

7. The substrate processing apparatus according to claim 4, comprising a plurality of such processors that are moved independently of each other by the positioning device and imaged by the single imaging device.

8. The substrate processing apparatus according to claim 4, wherein the substrate holder holds the substrate in a horizontal posture, and
the positioning device makes the processor move horizontally.

9. The substrate processing apparatus according to claim 4, comprising a positioning determining device that determines that the position of the processor is inappropriate when the size of displacement of the processor from the reference position exceeds a threshold value set in advance.

10. The substrate processing apparatus according to claim 4, comprising a holding state determining device,
wherein the imaging device at least partially images the substrate which is held by the substrate holder, and
the holding state determining device determines how the substrate is held by the substrate holder based upon the result of imaging concerning the substrate.

11. The substrate processing apparatus according to claim 4, wherein the processor is a fluid supplier which supplies a predetermined processing fluid to the substrate.

12. The substrate processing apparatus according to claim 4, wherein the processor is an abutting device that abuts on the surface of the substrate and processes the substrate.

13. A displacement detection method of detecting displacement of an object to be positioned from a reference position, the method comprising:
an imaging step of imaging the object or a member which is displaced together with the object as a subject to be imaged and obtaining an subject image of the subject; and
a detecting step of detecting displacement of the object based upon the subject image,
wherein at the imaging step, the subject is imaged in an imaging direction having a parallel component to the direction of displacement of the subject and a non-parallel component to the direction of displacement, and
at the detecting step, a non-parallel component to the imaging direction included in displacement of the object from the reference position is detected based upon the result of pattern matching of the subject image against a reference image of the subject which is taken by the imaging device with the object positioned at the reference position.

14. The displacement detection method according to claim 13, wherein prior to the detecting step, the reference image is obtained by imaging the object set to the reference position within the same field of view as that for the subject image, and
at the detecting step, displacement of the object is detected based upon how the position of the subject is different between the reference image and the subject image.

15. The displacement detection method according to claim 13, wherein, information, regarding the position of a partial image corresponding to the subject inside the reference image, is obtained as reference information, and
at the detecting step, the position of a partial image corresponding to the subject inside the subject image is identified, and the identified information is compared with the reference information to detect displacement of the object is detected.

16. A substrate processing method, comprising:
a substrate holding step of holding a substrate;
a processor arranging step of moving a processor which performs predetermined processing of the substrate to a reference position set in advance and positioning the processor so that the processor is opposed to the substrate;
a processing step of making the processor perform the processing of the substrate;
an imaging step of imaging the processor or a member which is displaced together with the processor as a subject to be imaged and obtaining an subject image of the subject; and
a detecting step of detecting displacement of the processor based upon the subject image,
wherein at the imaging step, the subject is imaged in an imaging direction which has a parallel component to the direction of displacement of the subject and a non-parallel component to the direction of displacement,
at the detecting step, a non-parallel component to the imaging direction in displacement of the processor from the reference position is detected based upon the result of pattern matching of the subject image against a reference image of the subject which is taken by the imaging device with the processor positioned at the reference position, and
prior to the processing step, the imaging step and the detecting step are executed to determine whether the processor is positioned at the reference position is determined.

17. The substrate processing method according to claim 16, wherein it is determined that the position of the processor is inappropriate when the size of displacement of the processor from the reference position exceeds a threshold value set in advance.

18. The substrate processing method according to claim 17, comprising a teaching step of accepting user's work of positioning the processor and storing this position as the reference position before the processor arranging step,
wherein the teaching step is executed again when the position of the processor is inappropriate.

19. The substrate processing method according to claim 16, comprising a holding state determining step of at least partially imaging the substrate which is held at the substrate holding step and determining how the substrate is held based upon the result of imaging,
wherein the holding state determining step is executed prior to the processing step.
